(19) United States
(12) Patent Application Publication
(10) Pub. No.: US 2007/0170023 A1
(43) Pub. Date: Jul. 26, 2007

(54) Disc brake pad, back plate for pad and method of manufacturing back plate for pad

(76) Inventor: Katsuhiro Yamamoto, Higashimatsuyama-Shi (JP)

Correspondence Address: DARBY & DARBY P.C., P.O. BOX 770, Church Street Station, New York, NY, 10008-0770, US

(21) Appl. No.: 11/347,508

(22) Filed: Feb. 2, 2006

(30) Foreign Application Priority Data
Jan. 26, 2006 (JP) 2006-17058

(51) Int. Cl. F16D 65/00

(52) U.S. Cl. 188/250 G; 188/250 E

(57) ABSTRACT

A back plate for a disc brake pad including a friction material fixing face provided to one surface of the back plate so that a friction material is fixed to the friction material fixing face, and plural projections provided to the friction material fixing face so as to project to the friction material side. The projections are formed by pressing (for example, stamping) the back plate from the other surface thereof at the opposite side to the friction material fixing face in a progressive working based on fine blanking press so that the projections concerned are extruded from the friction material fixing face.

### BACKGROUND OF THE INVENTION

1. Field of the Invention

The present invention relates to a disc brake pad mounted in a disc brake used for braking of a vehicle, a railcar, an industrial machine or the like, a back plate for a disc brake pad (hereinafter referred to as “backplate”) used for supporting a friction material of the disc brake pad, and also a method of manufacturing the back plate.

2. Description of the Related Art

A general type disc brake used for vehicles, etc. is equipped with a disc-shaped brake disc that is secured to a rotating axle side and rotates together with the axle, and a caliper that is secured to the main body side of the vehicle and pinches the peripheral edge portion of the brake disc from both the side surfaces thereof. The caliper is equipped with a pair of disc brake pads, and these disc brake pads are disposed so as to be spaced from each other at a predetermined interval and confront each other through the brake disc. Each of the disk brake pads is constructed by a flat-plate type back plate, and a friction material formed of an organic type composite material. One flat surface of the back plate is secured to the caliper side, and the other flat surface of the backplate is fixed to the friction material through adhesive agent or the like.

The caliper is designed so as to pinch the brake disc from both the sides thereof by hydraulic pressure when a driver works a brake pedal. Accordingly, when the driver works the brake pedal, the rotating brake disc is pinched under pressure by the friction material provided to the disc brake pads, and thus the rotational kinetic energy of the brake disc is converted to frictional heat, whereby the rotation number of the brake disc, that is, the rotation number of the axle is reduced.

In this type of disc brake, the braking force of the brake directly acts on the disk brake pads. More specifically, the braking force occurring through the sliding motion between the brake disc and each friction material acts as shearing force in the thickness direction of the back plate, and also acts to exfoliate the friction material from the back plate.

Recently, the braking characteristics of vehicles, etc. have been more and more enhanced by the enhancement of the friction performance of the friction material, and thus the shearing force acting on the back plate is more intense. For example, if the thickness of the back plate is increased to enhance the strength of the back plate, the cost of the material rises up and the weight of the material also increases because of the thickness of the material is increased, so that the disc brake increases in size.

Furthermore, the disk brake pad is an important safety part in vehicles, etc., and thus it is particularly required to keep the sufficient adhesion strength between the back plate and the friction material.

### SUMMARY OF THE INVENTION

The present invention has been implemented in view of the foregoing situation, and has an object to provide a back plate for a disc brake pad that can endure large shearing force without increasing the thickness of the back plate, and enhance the strength of the adhesion to a friction material, and a method of manufacturing the back plate concerned.

Furthermore, the present invention has another object to provide a disc brake pad using the back plate.

In order to attain the above object, according to a first aspect of the present invention, there is provided a back plate for a disc brake pad comprising: a friction material fixing face provided to one surface of the back plate so that a friction material is fixed to the friction material fixing face; and plural projections provided to the friction material fixing face so as to project to the friction material side.

According to the above construction, the section modulus of the back plate in the plate thickness can be increased by the plural projections, and also the plural projections intruding into the friction material are engaged with the friction material, thereby countervailing the braking force acting to exfoliate the friction material from the back plate.

Furthermore, the projections maybe formed by pressing the back plate from the other surface thereof at the opposite side to the friction material fixing face with a press member such as an embossing punch or the like so that the projections concerned are extruded from the friction material fixing face.

According to the above construction, the projections may be formed by a general press working or the like.

In this case, the projections may be formed by the progressive working based on fine blanking press, whereby occurrence of unevenness, burr, etc. on the friction material fixing face of the back plate can be prevented.

Furthermore, in the above construction, the back plate may be equipped with groove portions on the other surface at the opposite side to the friction material fixing face so that each groove portion and each projection confront each other through the body of the back plate. In this case, each groove portion may be designed to have substantially the same volume as each projection.

In the above construction, each of the projections is equipped with a recess portion concaving in the opposite direction to the projecting direction of the projections. In this case, the recess portion may be provided to the upper surface portion of each of the projections.

According to the above construction, the friction material intrudes into each recess portion, and thus the engagement between each projection and the friction material is further enhanced, so that the exfoliation of the friction material from the back plate can be more surely prevented.

Furthermore, in the above construction, each of the projections may be designed to have a round shape in plan view.

According to a second aspect of the present invention, there is provided a method of manufacturing a back plate for a disc brake pad, the back plate being equipped with a friction material fixing face on one surface thereof to which a friction material is fixed, that comprises the step of pressing the back plate from the other surface thereof at the opposite side to the friction material fixing face with a press member to form projections on the friction material fixing face.

According to this manufacturing method, the plural projections can be easily formed on the friction material fixing face by the progressive working based on press, for example. In this case, the projections may be formed by the progressive working based on fine blanking press. According to this method, the plural projections can be formed without occurrence of unevenness, burr, etc. on the frictional material fixing face.

According to a third aspect of the present invention, there is provided a disc brake pad comprising: a back plate having a friction material fixing face on one surface thereof; and a friction material fixed to the friction material fixing face of the back plate, wherein the back plate is equipped with plural projections projecting into the friction material, the plural projections being formed on the friction material fixing face of the back plate by pressing the back plate from the other surface thereof at the opposite side to the friction material fixing face.

According to the above construction, the disc brake pad can be designed so that the projections are located in the friction material under the state that the friction material is fixed to the friction material fixing face.

Furthermore, the projections may be formed by the progressive working based on fine blanking press.

According to the above construction, there can be provided the disc brake pad in which the flat surface of the friction material and the flat surface of the friction material fixing face of the back plate can be brought into close contact with each other and the adhesion strength therebetween can be enhanced.

According to the present invention, the plural projections are formed on the friction material fixing face so as to project to the friction material by pressing the surface of the back plate at the opposite side to the frictional member fixing face of the back plate. Therefore, the following effects can be achieved.

(1) The section modulus in the plate thickness direction of the back plate is increased, and thus the back plate can sufficiently countervail the shear stress acting on the back plate.

(2) The strength of the back plate is greatly enhanced by extruding the plural projections from the body of the back plate with the press member,

and thus large shear stress can be sufficiently countervailed. Accordingly, it is unnecessary to increase the thickness of the back plate, and thus the cost of the material of the back plate can be reduced. Furthermore, the problem of the large-size design of the disc brake which is caused by the increase of the plate thickness of the back plate can be prevented.

(3) When the friction material is adhesively attached to the friction material fixing face, the plural projections intrude (bite) into the friction material, and thus the plural projections are firmly engaged with the friction material. Accordingly, the braking force acting in such a manner as to exfoliate the friction material from the back plate can be countervailed by the firm engagement between the projections and the friction material.

(4) The adhesion area between the friction material and the back plate can be increased, and thus the adhesion strength can be enhanced. Furthermore, even when corrosion such as rust or the like occurs due to invasion of rain water or the like, the adhesion strength can be kept as high as possible.

(5) The amount of the friction material to be used can be reduced by the amount corresponding to the volume of the plural projections. Therefore, the cost of the material of the friction material can be reduced.

Furthermore, the plural projections are formed by the progressive working based on the fine blanking press. Therefore, occurrence of unevenness, burr, etc. on the friction material fixing face which has been unavoidable in the conventional techniques can be prevented by the manufacturing method of the present invention. Therefore, the flatness of the friction material fixing face can be enhanced, and the flat surface of the fixing face of the friction material and the flat surface of the friction material fixing face can be brought into close contact with each other. Therefore, the friction material fixing face and the friction material can be firmly adhesively attached to each other by adhesive agent or the like, whereby the braking force acting to exfoliate the friction material from the back plate can be countervailed.

Furthermore, the recess portion concaving in the direction opposite to the projecting direction of the projection is formed at the top portion of the projection. Therefore, when the friction material is fused to adhere to the friction material fixing face, the friction material thus fused intrudes into the recess portions. Therefore, the engagement between each recess portion and the friction material intruding into the recess portion can more sufficiently countervail the braking force acting to exfoliate the friction material from the back plate.

According to the method of manufacturing the back plate, when the surface of the back plate at the opposite side to the friction material fixing face of the back plate is pressed by the press member, the projections can be formed on the friction material fixing face while restraining the flat surface of the friction material fixing face through the progressive working based on fine blanking press. Therefore, occurrence of unevenness, burr, etc. on the frictional material fixing face can be prevented, and the flatness of the friction material fixing face can be enhanced. Accordingly, the flat surface of the friction material can be brought into close contact with the flat surface of the friction material fixing face with no clearance, and the friction material fixing face and the friction material can be firmly adhesively attached to each other by adhesive agent or the like. As a result, the braking force acting to exfoliate the friction material from the back plate can be countervailed.

### BRIEF DESCRIPTION OF THE DRAWINGS

FIG. 1 is a diagram showing a disc brake using a back plate according to an embodiment of the present invention;

FIG. 2A is a front view showing a disc brake pad using the back plate according to the embodiment of the present invention, FIG. 2B is a lower side view of the disc brake pad of FIG. 2A which partially contains a cross-sectional view, and FIG. 2C is an enlarged cross-sectional view of a projection shown in FIG. 2B;

FIG. 3A is a front view showing a back plate according to the embodiment of the present invention, FIG. 3B is a lower side view of the back plate of FIG. 3A which partially contains a cross-sectional view, and FIG. 3C is an enlarged cross-sectional view of a projection;

FIG. 4A is a front view showing the disc brake pad using the back plate when the mold hole of FIG. 2A is not formed, and FIG. 4B is a lower side view of the disc brake pad of FIG. 4A which partially contains a cross-sectional view;

FIG. 5A is a front view showing the back plate of the embodiment of the present invention when no mold hole of FIG. 3A is provided, and FIG. 5B is a lower side view of the back plate of FIG. 5A which partially contains a cross-sectional view;

FIG. 6A is a front view showing a manufacturing apparatus (mold) for manufacturing the back plate of the embodiment by progressing working based on fine blanking press, and FIG. 6B is a cross-sectional view of the manufacturing apparatus of FIG. 6A;

FIGS. 7A and 7B are diagrams showing diagram showing a coil material when the back plate according to the embodiment is manufactured by the progressive working based on the fine blanking press, wherein FIG. 7A is a front view showing a state where the coil material is manufactured every step, and FIG. 7B is a cross-sectional view of FIG. 7A; and

FIGS. 8A to 8H are diagrams showing a test of the back plate according to the embodiment of the present invention.

### DETAILED DESCRIPTION OF THE PREFERRED EMBODIMENTS

Preferred embodiments according to the present invention will be described hereunder with reference to the accompanying drawings.

First, a back plate for a disc brake pad (hereinafter referred to as “back plate”) according to an embodiment of the present invention will be described hereunder with the accompanying drawings.

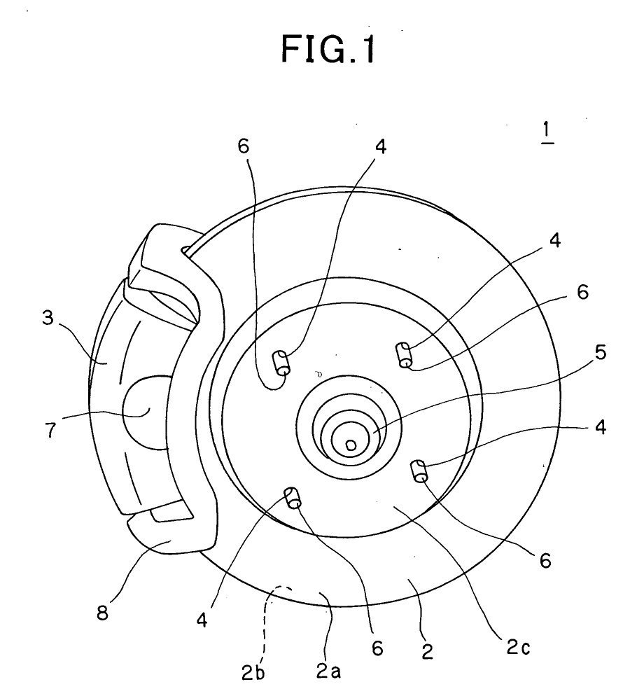

FIG. 1 is a diagram showing a disc brake using the back plate according to the embodiment of the present invention.

A disc brake 1 used for a vehicle or the like is equipped with a brake disc 2 rotatable together with an axle 5, and a caliper 3 disposed at the peripheral edge portion of the brake disc 2.

As shown in FIG. 1, the brake disc 2 is designed in a disc-like shape having a hub 2c at the center portion thereof, and also two flat face portions 2a and 2b along which friction materials described later frictionally slide are provided to the outer peripheral edge portion of the disc plate. Furthermore, the hub 2c at the center portion of the brake disc 2 is provided with four fixing holes 4 penetrating through the hub 2c in the plate thickness direction, and four studs 6 projecting from the axle 5 side are inserted through the fixing holes 4. Accordingly, the brake disc 2 is rotated together with the axle 5.

As shown in FIG. 1, the caliper 3 is designed so as to pinch the flat face portions 2a, 2b of the brake disc 2 from the outside thereof, and the disc brake pads 7 are fixed to the inside of the caliper 3 (the side facing the flat face portions 2a, 2b). Furthermore, a bracket 8 for guiding the disc brake pads 7 in the plate thickness direction of the brake disc 2 is provided to the outside of the caliper 3.

A piston (not shown) moved by hydraulic pressure or the like is provided to the caliper 3. The piston is designed so as to press the disc brake pads 7 to the brake disc 2 when a driver works a brake pedal, and the thus-pressed disc brake pads 7 are guided to the flat face portions 2a, 2b by the bracket 8 so as to come into contact with the flat face portions 2a, 2b.

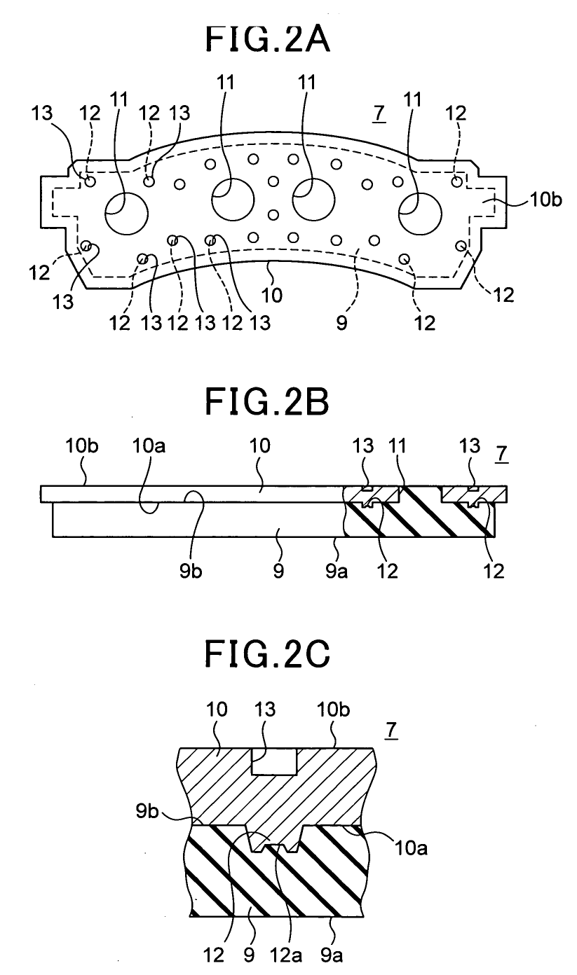

FIG. 2A is a front view showing the disc brake pad 7, and FIG. 2B is a lower side view of the disc brake pad 7 of FIG. 2A which is viewed from the lower side and partially contains a cross-sectional view. FIG. 2C is a partially enlarged view of the cross-section of FIG. 2B. Each disc brake pad 7 comprises a friction material 9 and a back plate 10 to which the friction material 9 is fixed. The disc brake pad 7 is designed to have a curved arcuate shape, which is conformed with the outer shape of the outer peripheral edge portion of the brake disc 2.

As shown in FIG. 2B, the friction material 9 is designed in the form of a flat plate so as to have a sliding flat face 9a and a fixing face 9b at the opposite side to the sliding flat face 9a, and the flat face portion 2a or 2b of the brake disc 2 frictionally slide against the sliding flat face 9a of the friction material 9 while pressed by the sliding flat face 9a. The same is also applied to the other friction material 9.

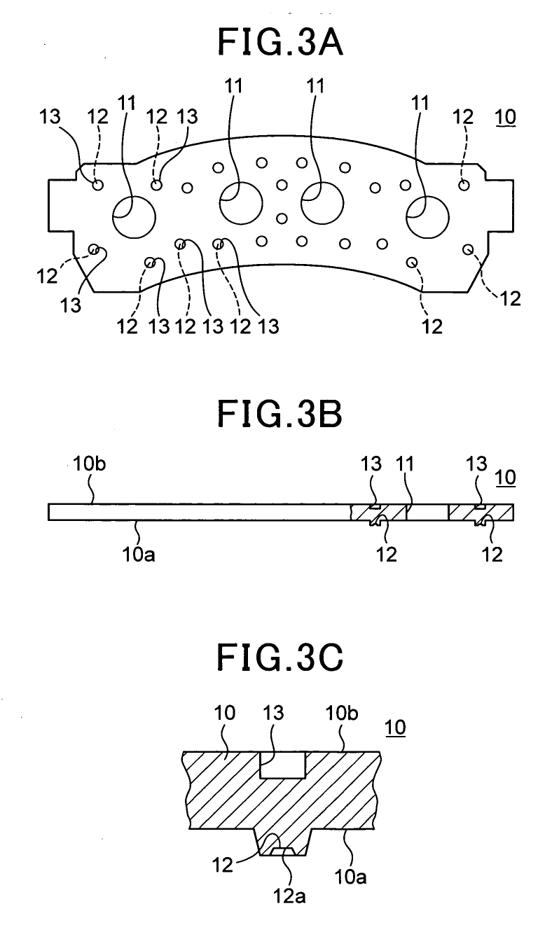

FIG. 3A is a front view showing the back plate 10 used for the disc brake pad 7, FIG. 3B is a lower side of the back plate 10 of FIG. 3A which is viewed from the lower side and partially contains a cross-sectional view. FIG. 3C is a partially enlarged view of the cross-section of FIG. 3B.

As shown in FIGS. 2A and 3B, the back plate 10 is designed in the form of a flat plate so as to have a friction material fixing face 10a and a fixing face 10b at the opposite side to the friction material fixing face 10a, and the fixing face 9b of the friction material 9 is made to adhere to the friction material fixing face 10a by adhesive agent or the like as shown in FIGS. 2A, 2B and 2C. The fixing face 10b of the back plate 10 is secured to the caliper 3.

As shown in FIGS. 3A and 3B, four mold holes 11 penetrating through the back plate 10 in the thickness direction thereof and plural projections 12 extending from the friction material fixing face 10a to the inside of the friction material 9 are formed in the back plate 10. The friction material 9 to be molded is made to intrude into the mold holes 11 as shown in FIG. 2B.

Each projection 12 is designed to be round (circular) in plan view as shown in FIG. 2A and also substantially rectangular in side view as shown in FIGS. 2B and 2c. The corner portion of each or some of the projections 12 may be subjected to C-chamfering or R-chamfering, or intentionally angulated. Furthermore, the projection 12 may be designed in such a tapered shape that the diameter thereof is gradually reduced toward the tip thereof. As described in detail later, the projection 12 is formed by pressing a pin (press member) from the fixing face 10b side into the body of the back plate 10 in the plate thickness direction. At this time, a groove (recess) portion 13 is simultaneously formed on the fixing face 10b as a result of the pressing of the pin (i.e., as a result of stamping). In this case, the volume of the recess portion of the groove portion 13 is substantially equal to the volume of the projecting portion. The dimension of the projection 12 is determined in accordance with the size and thickness of the back plate 10, however, it is preferable that the diameter of the projection 12 is equal to about 4 mm and the length of the projection ranges from about 2 mm to 5 mm.

As shown in FIG. 2C, the top portion of each projection 12 is designed to have a flat surface which is substantially parallel to the friction material fixing face 10a, and also a recess portion 12a is formed on the flat surface of the top portion so as to concave in the opposite direction (the upward direction in FIG. 2C) to the projecting direction (the downward direction in FIG. 2C) of the projection 12. The corner portion of the recess portion 12a may be subjected C-chamfering or R-chamfering, or intentionally angulated. The recess portions 12a are formed by the emboss supports 55 simultaneously with the formation of the projections 12 in the same forming step as the projections 12. The location of each recess portion 12a is not limited to the top surface of each projection 12, but the recess portion 12a may be formed on the side surface or the like of each projection 12. Furthermore, it is preferable to provide the recess portion 12a, however, it is not indispensable to provide the recess portion 12a.

The shapes of the projection 12 and the recess portion 12a as described above make it easier for the projection 12 to intrude (bite) into the friction material 9. More specifically, the friction material 9 is heated and molded (fused) on the friction material fixing face 10a, and thus seizure of the friction material 9 to the back plate 10 is carried out, whereby the friction material 9 firmly adhere to the friction material fixing face 10a of the back plate 10 through the projections 12, that is, the friction material 9 is put on the friction material fixing face 10a of the back plate 10 under the melted state, and then it firmly adheres to the projections 12 on the back plate 10 during its cooling. At this time, by providing adhesive agent or the like between the friction material 9 and the back plate 10, the adhesion between the friction material and the back plate is more strengthened.

Accordingly, the friction material 9 acts with the projections 12, and the projections 12 intrude into the friction material 9 by the surrounding pressure, so that the friction material 9 and the projections 12 are made to firmly adhere to each other. Accordingly, the back plate 10 and the friction material 9 are engaged with each other and thus the adhesion effect is enhanced. In addition, the contact area between the back plate 10 and the friction material 9 is increased, so that they can be prevented from being exfoliated from each other.

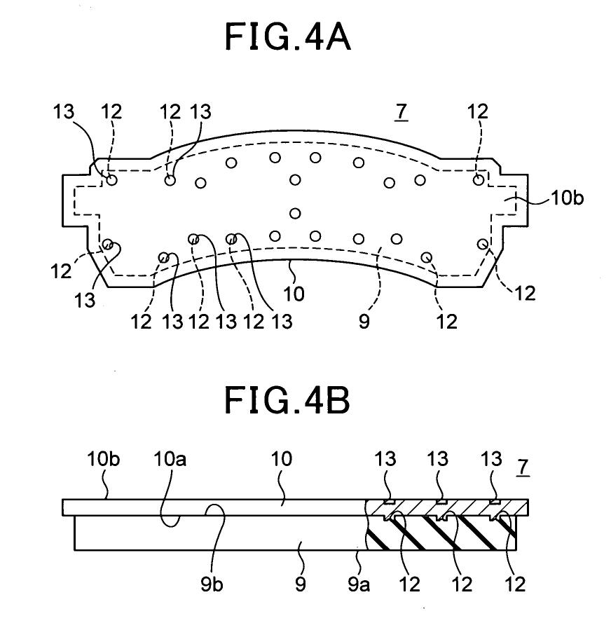

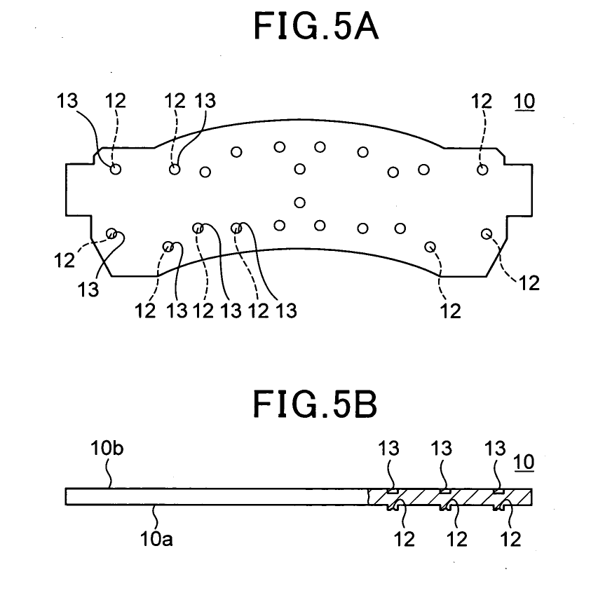

The back plate may be used for the disc brake pad without providing any mold hole 11 as shown in FIGS. 4 and 5. Here, FIG. 4a is a front view showing a disc brake pad 7 equipped with no mold hole, and FIG. 4B is a lower side view of the disc brake pad 7 and contains a partially cross-sectional view. FIG. 5A is a front view showing a back plate 10 used for the disc brake pad 7, and FIG. 5B is a lower side view of the back plate 10 and contains a partially cross-sectional view.

In the above embodiment, the overall rigidity of the back plate 10 can be enhanced by providing the projections 12 on the friction material fixing face 10a of the back plate 10 as described above. In addition, since no mold hole 11 is provided, no rust occurs at the cross-sectional portion of each mold hole 11 and thus there occurs no problem caused by rust.

Next, apparatus and method of manufacturing the back plate 10 described above will be described.

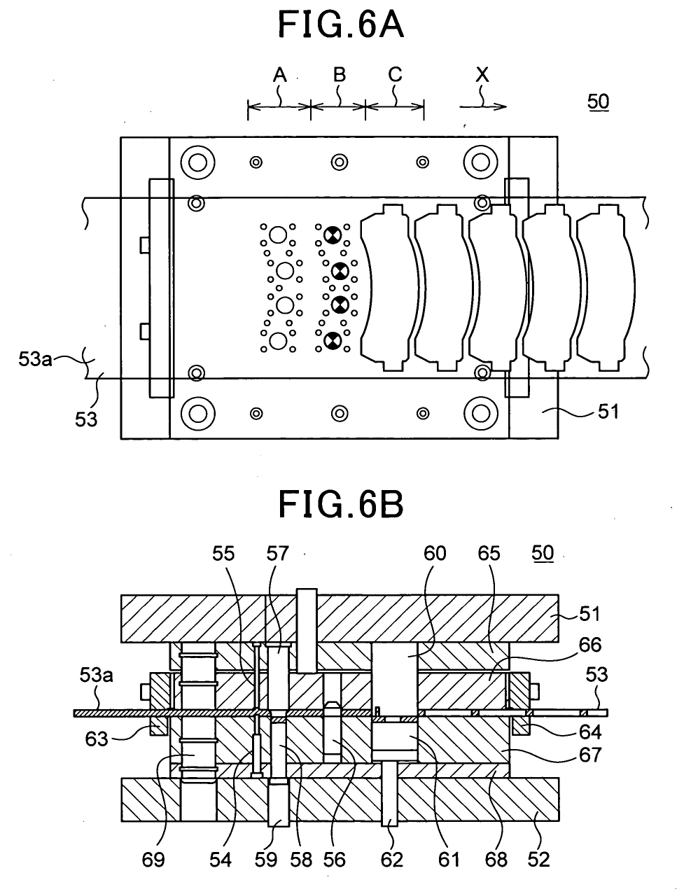

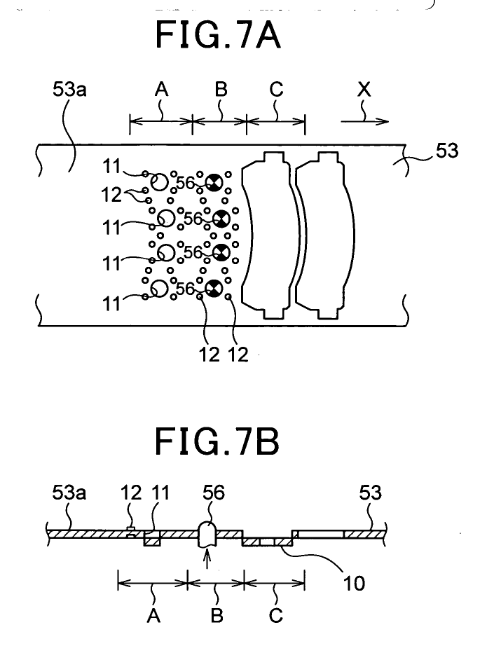

FIG. 6A is a front view showing a manufacturing apparatus (molding machine) used for the progressive working based on fine blanking press, and FIG. 6B is a cross-sectional view showing the manufacturing apparatus of FIG. 6A. FIGS. 7A and 7B are diagrams showing the manufacturing process of the progressive working based on the fine blanking press.

The mold holes 11, the projections 12 and the recess portions 12a are formed by the progressive working based on the fine blanking press.

Here, the progressive working based on the fine blanking press will be briefly described. According to this processing method, a part can be brought to completion at one stroke by stamping a workpiece with high precision. Furthermore, the progressive working based on the fine blanking press can eliminate secondary works such as cutting work, milling work, etc. which have been required to achieve outer frames and hole portions needed to parts in normal press working.

More specifically, according to the normal press working, the stamping is carried out by combining a punch and a die. That is, when the punch is downwardly moved and brought into contact with a material on the die under pressure so as to be pressed against the material, the material is bent and deformed. After the material passes through a shearing process, fractures occur in the material. Then, before the punch completely penetrates through the material, the stamping is finished. Therefore, the normal press working has various problems such as “sheared droop (die roll)/burr are large”, “many fractured surfaces, but small sheared surface”, “cutting surface is not vertical to the surface of material”, “the flat surface of the stamped product is not flat, but curved”, etc., and thus it requires secondary works in many cases.

On the other hand, the progressive working based on the fine blanking press is a method of stamping a material to be stamped while controlling the feeding operation of the material (the coil material) at the shearing portion of the material. Specifically, by using a punch and a die that are extremely small in clearance, high compression stress is induced in the material, and the ductility of the material is enhanced, whereby occurrence of crack is prevented, and vertical and beautiful sheared surfaces having no fracture can be achieved.

As shown in FIGS. 6A and 6B, the manufacturing apparatus 50 for the progressive working based on fine blanking press is equipped with an upper mold 51 and a lower mold 52, and the coil material 53 is progressively fed from the left side of the sheet surface of the drawing to the right side thereof in the direction of an arrow X between the upper mold 51 and the lower mold 52. The upper mold 51 is fixed, and the lower mold 52 is movable in the vertical direction. The upper side surface 53a of the coil material 53 serves as the friction material fixing face 10a of the back plate 10.

This manufacturing apparatus 50 is mainly equipped with the following parts as shown in FIG. 6B.

(1) Parts for Forming the Projections 12

(a) Embossing punches (pins or embossing punches) 54 that are provided to the lower mold 52 side and extrude the coil material 53 (press the coil material 53 upwardly in FIG. 6A).

(b) Emboss supports (emboss supports) 55 that are provided to the upper mold 51 side and receive the embossing punches 54.

(2) Parts for Forming the Mold Holes 11

(a) Pierce punches 57 that are provided to the upper mold 51 side and stamp the coil material 53.

(b) Injector punches 58 that are provided to the lower mold 52 side and extrude scraps stamped out from the coil material 53.

(c) Pierce pressure pins 59 that are provided to the lower mold 52 side and applying pressure to push out the scraps stamped out from the coil material 53

(3) Parts for Positioning the Coil Material 53

(a) Pilot members 56 that are provided to the lower mold 52 side, guide the feeding of the coil material 53 through the stamped mold holes 11 and break down the burr of the mold holes 11.

(4) Parts for Shaping the Outline of the Back Plate 10

(a) A main punch 60 that is provided to the upper mold 51 side and stamps the back plate 10 in conformity with the outline of the back plate 10.

(b) A counter support (opposing support) 61 that is provided to the lower mold 52 side and pushes out the stamped back plate 10.

(c) A counter pressure pin 62 that is provided to the lower mold 52 side and applies pressure to push out the stamped back plate 10.

(4) Other Parts

(a) An entrance guide member 63 for guiding the coil material and an exit guide member 64.

(b) An upper punch plate 65 for positioning each punch at the upper mold 51 side.

(c) A stripper plate 66 for stripping the stamped member from the mold.

(d) A die plate 678 for processing of products.

(e) A lower punch plate 68 serving as a stop plate for the injector punch.

(f) A guide post 69 for guiding the movement of the lower mold 52.

The back plate 10 is completed through totally three steps A, B and C described below as shown in FIGS. 7A and 7B.

In the first step A, the lower mold 52 is upwardly moved, and the material of the coil material is stamped (the term of “stamp” broadly covers the meaning of “embossing”) by the embossing punches (pins) 54 and the emboss supports 55 to form the projections 12, and also stamped out by the pierce punches 57 to form the mold holes 11. In this step, the processing is carried out under the state that the flat face of the upper surface 53a of the coil material (the friction material fixing face 10a) is restrained by the upper mold 51. Accordingly, neither unevenness nor burr occurs on the upper surface 53a of the coil material 53 by using even the processing of the flat face thereof. Furthermore, when the projections 12 are formed by the embossing punches 54, the recess portions 55 are simultaneously formed by the emboss supports 55. As described above, at the same time when the coil material 53 is stamped by the embossing punches 54 to form the projections 12, the groove portions 13 are also formed by the embossing punches 54. In this case, each groove portion and each projection are formed on the fixing face 10b and the friction material fixing face 10a of the back plate as if they confront each other through the body of the back plate. Furthermore, the volume of each projection 12 is substantially equal to that of the corresponding groove portion 13.

In the second step B, after the coil material 53 is fed by the amount corresponding to one step, the positioning pilot members 56 are inserted into the mold holes 11 to position the coil material 53. The positioning pilot members 56 are used to carry out the positioning of the progressively-fed coil material 53 with high precision. When no mold hole 11 is formed in the back plate 10, the positioning of the coil material 53 may be carried out as follows. That is, a hole(s) (not shown) is provided out of the outline of the stamp-scheduled portion of the back plate 10, and another pilot member(s) (not shown) to be inserted in the hole(s) is provided at the lower mold 52 side. Under this situation, the other pilot member(s) is inserted into the hole(s) to position the coil material 53.

In the third step C, after the coil material 53 is further fed by the amount corresponding to one step, the position of the coil material 53 is settled by the pilot members 56 in the second step B, and then the coil material 53 is stamped in conformity with the outline of the back plate 10 by using the main punch 60, the die plate 67 and the counter support 61.

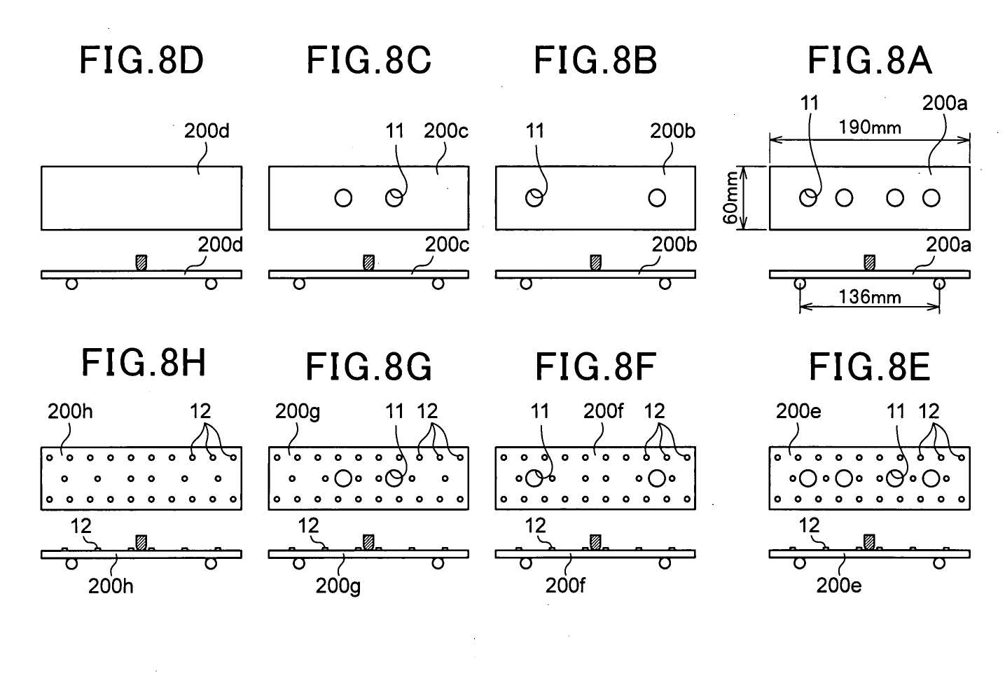

Next, strength test results of the back plate 10 according to the above-described embodiments will be described with reference to FIGS. 8A to 8H.

In this test, rectangular test pieces 200a to 200h (60 m in longitudinal length, 190 mm in lateral length, 5.5 mm in plate thickness) shown in FIGS. 8A to 8H were used in place of the back plate 10. The test content was as follows. A load was applied to the center portion of each of the test pieces 200a to 200h from the upper side thereof while both the sides of each test piece are supported from the lower side, and the load (Fa to Fh) when the center portion of the test piece sagged downwardly by 4 mm was measured. In this test, each test piece was supported at both the edge portions in the lateral direction thereof over the whole length thereof by supporting members, and the supporting members were disposed at a pitch of 136 mm.

In the case of the test piece 200a shown in FIG. 8A, four mold holes were formed in alignment with one another in the lateral direction, however, no projection 12 was formed. The measurement result of the test piece 200a indicated that the load Fa was equal to 474 kgf.

In the case of the test piece 200b shown in FIG. 8B, two mold holes 11 were formed to be remote from the center portion, and no projection 12 was formed. The measurement result of the test piece 200b indicated that the load Fb was equal to 526 kgf.

In the case of the test piece 200c shown in FIG. 8C, two mold holes 11 were formed to be near to the center portion, and no projection 12 was formed. The measurement result of the test piece 200c indicated that the load Fc was equal to 489 kgf.

In the case of the test piece 200d shown in FIG. 8D, neither mold hole 11 nor projection 12 was formed. The measurement result of the test piece 200d indicated that the load Fd was equal to 534 kgf.

In the case of the test piece 200e of FIG. 8E, four mold holes were formed in alignment with one another in the lateral direction, and plural projections 12 were also formed. That is, plural projections 12 were provided to the test piece 200a. The measurement result of the test piece 200e indicated that the load Fe was equal to 663 kgf.

In the case of the test piece 200f shown in FIG. 8F, two mold holes 11 were formed to be remote from the center portion, and plural projections 12 were formed. That is, plural projections 12 were provided to the test piece 200b. The measurement result of this test piece 200f indicated that the load Ff was equal to 689 kgf.

In the case of the test piece 200g shown in FIG. 8G, two mold holes were formed to be near to the center portion and plural projections 12 were formed. That is, the plural projections 12 were provided to the test piece 200c. The measurement result of the test piece 200g indicated that the load Fg was equal to 670 kgf.

In the case of the test piece 200h shown in FIG. 8H, no mold hole 11 was formed, but plural projections 12 were formed. That is, the plural projections 12 were provided to the test piece 200d. The measurement result of the test piece 200h indicated that the load Fh was equal to 695 kgf.

The following has been found from the above-described measurement results.

(1) Enhancement in Rigidity by Providing Projections 12

Comparing the case where plural projections 12 were provided with the case where no projection was provided,

(A) Fe−Fa=+189 kgf (see FIG. 8A and FIG. 8E)

(B) Ff−Fb=+163 kgf (see FIG. 8C and FIG. 8G)

(C) Fg−Fc=+181 kgf (see FIG. 8C and FIG. 8G)

(D) Fh−Fd=+161 kgf (see FIG. 8D and FIG. 8H)

That is, it has been found that the whole strength is enhanced by providing the projections 12.

(2) Enhancement in Rigidity by Eliminating Mold Holes 11

Comparing the case where no mold hole 11 was provided with the case where four mold holes 11 were provided,

(A) Fd>Fb >Fc >Fa (see FIG. 8A to 8D)
Fd−Fa=+60 kgf
Fc−Fa=+15 kgf
Fb−Fa=+52 kgf

(B) Fh>Ff>Fg>Fg (see FIG. 8E to 8H)
Fh−Fe=+32 kgf
Fg−Fe=+7 kgf
Fg−Fe=+26 kgf
Accordingly, it has been found that the whole strength is enhanced as the number of mold holes 11 is smaller.

(3) Relationship Between the Position of the Mold Holes 11 and the Rigidity

In the case where the two mold holes 11 were symmetrically provided with respect to the center line, comparing the case where the pitch of the mold holes 11 was large with the case where the pitch of the mold holes 11 were small, it has been found that the strength was higher when the mold holes 11 were disposed to be remote from the center portion (i.e., the pitch of the mold holes 11 was larger) than the cases (A) and (B) of (2).

From the above-described results, in order to enhance the rigidity of the back plate 10, it is preferable that (1) the projections 12 are provided, (2) the mold hole 11 is eliminated, or (3) when the mold holes 11 are provided, the pitch thereof is set to a large value.

According to the back plate 10 of the above-described embodiment of the present invention, by forming the plural projections 12 on the back plate 10, the plural projections 12 are engaged with the friction material 9, thereby countervailing the braking force of exfoliating the friction material 9 from the back plate 10.

Furthermore, the adhesion area between the friction material 9 and the back plate 10 can be increased, so that the adhesion strength can be also enhanced. Accordingly, even when corrosion of rust or the like occurs due to invasion of rain water or the like, the adhesion strength can be kept as high as possible.

Still furthermore, the section modulus of the back plate 10 in the thickness direction can be increased, and the shearing stress acting on the back plate 10 can be sufficiently countervailed.

In this embodiment, since it is unnecessary to increase the thickness of the back plate 10, the cost of the material of the back plate 10 can be more greatly saved by about 30% or more as compared with the cost of the material of a back plate enhanced in strength by increasing the thickness thereof, and thus the weight of the back plate 10 can be reduced.

Furthermore, the use amount of the friction material 9 can be reduced by the amount corresponding to the total volume of the plural projections 12, and thus the cost of the friction material 9 can be reduced.

The plural projections 12 are formed by plastically deforming the back plate 10 while restraining the flat face of the friction material fixing face 10a through the progressive working based on the fine blanking press. Therefore, even when the processing of forming the projections 12 on the back plate 10 is carried out, the flatness of the flat surface of the back plate 10 can be kept to the same level as that before the processing concerned without occurrence of bending, unevenness, burr, etc. on the friction material fixing face 10a.

Furthermore, the recess portion 12a concaving in the opposite direction to the projecting direction of the projections 12 may be formed on the tip (top) portion of each of the plural projections 12. Therefore, when seizure of the friction material 9 to the friction material fixing face 10a is carried out, the friction material 9 intrudes into the recess portions 12a, and the engagement between the friction material 9 and each projection 12 can countervail the braking force of exfoliating the friction material 9 from the friction material fixing face 10a.

Still furthermore, the projections 12 and the recess portions 12a can be formed in one step by the progressive working based on the fine blanking press.

When no mold hole 11 is provided, the problem of rust occurring on the cross-section surface of the mold hole 11 can be avoided.

The foregoing description has been made on the preferred embodiments of the present invention, however, the present invention is not limited to these embodiments. Various modifications and changes can be made without departing from the subject matter of the present invention.

For example, in the above-described embodiments, the projections 12 are designed in the round (circular) shape in plan view. However, the shape of the projections 12 in plan view is not limited to the above shape, and it may be a polygonal shape such as a triangle or the like, a rectangular shape, an elliptical shape, a trapezoidal shape, a gourd-like shape or the like. Furthermore, the press working to form the projections 12, etc. is not limited to the progressive working based on the fine blanking press. For example, general press working such as cold-press, hot-press or the like may be used. Furthermore, the projections 12 may be formed by forging press working or the like. In the case of the press working, the respective center lines of the projection 12 and the groove portion 13 formed on the back plate 10 are coincident with each other in all the cases. However, the present invention is not limited to this style, and the center line of the groove portion 13 and the center line of the projection 12 may be displaced from each other.

What is claimed is:

1. A back plate for a disc brake pad comprising:
a friction material fixing face provided to one surface of the back plate, a friction material being fixed to the friction material fixing face of the back plate; and
plural projections provided to the friction material fixing face so as to project to the friction material side.

2. The back plate according to claim 1, wherein the projections are formed by pressing the back plate from the other surface thereof at the opposite side to the friction material fixing face to the body of the back plate with a press member so that the projections concerned are extruded from the friction material fixing face.

3. The back plate according to claim 1, wherein the back plate has groove portions on the other surface at the opposite side to the friction material fixing face so that each groove portion and each projection confront each other through the body of the back plate.

4. The back plate according to claim 3, wherein each groove portion is designed to have substantially the same volume as the corresponding projection.

5. The back plate according to claim 1, wherein the projections are formed by progressive working based on fine blanking press.

6. The back plate according to claim 1, wherein each of the projections is equipped with a recess portion concaving in the opposite direction to the projecting direction of the projections.

7. The back plate according to claim 6, wherein the recess portion is provided to the upper surface portion of each of the projections.

8. The back plate according to claim 1, wherein each of the projections is designed to have a round shape in plan view.

9. A method of manufacturing a back plate for a disc brake pad, the backplate having, on one surface thereof, a friction material fixing face to which a friction material is fixed; comprising the step of pressing the back plate from the other surface thereof at the opposite side to the friction material fixing face to the body of the back plate with a press member to form projections on the friction material fixing face.

10. The method according to claim 9, wherein the projections are formed by progressive working based on fine blanking press.

11. A disc brake pad comprising:
a back plate having a friction material fixing face on one surface thereof; and
a friction material fixed to the friction material fixing face of the back plate, wherein the back plate is equipped with plural projections projecting into the friction material, the plural projections being formed on the friction material fixing face of the back plate by pressing the back plate from the other surface thereof at the opposite side to the friction material fixing face.

12. The disc brake pad according to claim 10, wherein the projections are formed by progressive working based on fine blanking press.
